(19) United States
(12) Patent Application Publication
(10) Pub. No.: US 2003/0046149 A1
(43) Pub. Date: Mar. 6, 2003

(54) Method, an apparatus, and a computer program for effectively reaching a target audience and significantly increasing the efficiency of internet banner advertisement

(76) Inventor: Yean Yee Wong, Chicago, IL (US)

Correspondence Address: Yean Yee Wong, 332 W. Cermak Rd. #2B, Chicago, IL, 60616, US

(21) Appl. No.: 09/882,771

(22) Filed: Jun. 18, 2001

(51) Int. Cl. G06F 17/60

(52) U.S. Cl. 705/14; 705/27

(57) ABSTRACT

This invention comprises (a) generating a request for said character set by a client of a character-generating server, (b) sending said request by said client to said character-generating server, (c) generating a pseudo random number required by said character generator; (d) sending said pseudo random number to said character generator; (e) generating a character for said character set by said character generator, (f) sending said character set along with a related key by said character-generating server to said client; (g) sending said character set along with said related key to a target server, said target server connecting to said character-generating server through said network interface, (h) sending said related key to said character-generating server by said target server; (i) recreating said character set from said related key by said target server; and (j) sending said character set along with said related key to said target server.

### BACKGROUND OF THE INVENTION

1. Field of the Invention

This invention relates to the World Wide Web, and more particularly, to a method, apparatus, and computer program product for effectively reaching a target audience and significantly increasing the efficiency of Internet banner advertisement.

2. Description of the Prior Art

Computers and the Internet have become a most significant part of modern communication. More and more people start to spend significant time surfing Internet on a daily basis. Internet becomes an effective media for advertisements to reach a large amount of audience. The problem of the online advertising is how to present the advertisements to the audience, who will be interested in the contents of the advertisements.

Various inventions have been made to solve this problem. U.S. Pat. No. 6,009,410, which issued to LeMole et al., discloses a Method and System for Presenting Customized Advertising to a User on the World Wide Web. In this invention, a customized advertising repository server is connected on the World Wide Web (WWW), which can be accessed by a registered user through his or her browser either by clicking on an icon, or by inputting the specific URL address of the particular server which stores that user's advertising repository. When the user accesses his or her customized ad repository through the browser, a composite advertising page is dynamically configured by the Customized Advertising Repository (CAR) server for that particular user based on that user's previously provided user profile. Furthermore, at least a portion of that composite advertising page can be dynamically configured on a context dependent basis determined from the particular Web site or sites that the user has accessed prior to accessing the CAR. The dynamically configured composite page or pages of advertising provided to the user may contain plural static images, streaming banners, 3-D images, animation, video and/or audio clips, using any of the technologies available on the Web for presenting textual and/or visual information. Such a composite page or pages is configured from a database which stores such images, banners, animation, etc., from plural advertisers. The customized page is created by selecting from among a storehouse of plural different subscribing advertisers and their associated banner ads, images, etc., those particular images, etc. that will be elements of the customized page based on the user's specific areas of interest as determined from the profile, and/or the context dependency. From such dynamically configured composite page or pages, the user can then click on a particular image, video window, banner, etc., to retrieve, through a hyperlink, further information directly from the selected advertiser's own Web site or mirror Web site.

U.S. Pat. No. 6,128,651, which issued to Cezar, discloses an Internet Advertising With Controlled and Timed Display of Ad Content From Centralized System Controller. In this invention, a non-scrolling ad display is lodged in a website to cause browsers hitting the website to undertake centrally controlled and recorded ad display for guaranteed minimum timed intervals. The system enables precise controlled advertising to each web page viewing browser and accurate advertising budgeting and programming which can be monitored and upgraded to meet marketing needs. The components participating in the system include a website at a web server for transmitting a page with code for installing a non-scrolling ad frame. Ad content for the non-scrolling ad frame each have individual timers for timing out commencing with display at the browser and an Internet address for fetching by the browser. A central controller with a firewall protected data base directs non-scrolling frame set up in the browser; generates, dispenses and interrogates for unique browser identifiers; maintains records associated with the unique browser identifiers indicating ads displayed and ads available for display; and, finally dispatches to inquiring browsers ad content addresses. The data base provides an audit trail from which websites can be compensated for ad display and advertisers billed for the ad display. Finally, an inquiring browser has the non-scrolling frame set up on the browser, ad content displayed within the browser for a sufficient time interval to timeout the timer, report to the central controller of the display, and retrieval of the address of the next ad content for display.

U.S. Pat. No. 6,141,010, which issued to Hoyle, discloses a Computer Interface Method and Apparatus with Targeted Advertising. This invention discloses a method and apparatus for providing an automatically upgradeable software application that includes targeted advertising based upon demographics and user interaction with the computer. The software application is a graphical user interface that includes a display region used for banner advertising that is downloaded from time to time over a network such as the Internet. The software application is accessible from a server via the Internet and demographic information on the user is acquired by the server and used for determining what banner advertising will be sent to the user. The software application further targets the advertisements in response to normal user interaction, or use, of the computer. Associated with each banner advertisement is a set of data that is used by the software application in determining when a particular banner is to be displayed. This includes the specification of certain programs that the user may have so that, when the user runs the program (such as a spreadsheet program), an advertisement will be displayed that is relevant to that program (such as an advertisement for a stock brokerage). This provides two-tiered, real-time targeting of advertising—both demographically and reactively. The software application includes programming that accesses the server on occasion to determine if one or more components of the application need upgrading to a newer version. If so, the components are downloaded and installed without requiring any input or action by the user.

However, none of the inventions disclosed by these patents are capable of providing a method for effectively reaching a target audience and significantly increasing the efficiency of Internet banner advertisement.

Accordingly, it is a principal object of my invention to provide a method for effectively reaching a target audience and significantly increasing the efficiency of Internet banner advertisement.

It is a further object of my invention to provide an apparatus for effectively reaching a target audience and significantly increasing the efficiency of Internet banner advertisement.

It is a still further object of my invention to provide a computer program product for effectively reaching a target audience and significantly increasing the efficiency of Internet banner advertisement.

It is a further object of my invention to provide a method for an advertiser to present the Internet banner advertisements to only those target audience, whose interesting level to these advertisements has reached the interesting level pre-defined by the advertiser.

It is a further object of my invention to provide an apparatus for an advertiser to present the Internet banner advertisements to only those target audience, whose interesting level to these advertisements has reached the interesting level pre-defined by the advertiser.

It is a further object of my invention to provide a computer program product for an advertiser to present the Internet banner advertisements to only those target audience, whose interesting level to these advertisements has reached the interesting level pre-defined by the advertiser.

### SUMMARY OF THE INVENTION

According to my present invention I have provided a method, an apparatus, and a computer program product for effectively reaching a target audience and significantly increasing the efficiency of Internet banner advertisement.

The method for effectively reaching a target audience and significantly increasing the efficiency of Internet banner advertisement comprises (a) defining various Internet page categories using common categorizing techniques adopted by various Internet search engines, (b) categorizing all available Internet banner advertisements into the various Internet page categories, (c) sampling a plurality of consecutive Internet pages a target audience having just surfed, (d) sampling a plurality of length of time the target audience having spent on each of the plurality of consecutive Internet pages the target audience having just surfed, (e) categorizing the plurality of consecutive Internet pages into a plurality of Internet page categories using the common categorizing techniques adopted by various Internet search engines, (f) counting number of the plurality of consecutive Internet pages in each of the plurality of Internet page categories, (g) ranking the plurality of Internet page categories from a highest interest Internet page category to a lowest interest Internet page based on a pre-defined formula, the plurality of length of time the target audience having spent on each of the plurality of consecutive Internet pages and the number of the plurality of consecutive Internet pages in each of the plurality of Internet page categories being two variables of the pre-defined formula, (h) picking a plurality of Internet banner advertisements in the highest interest Internet page category; and the highest interest Internet page category being one of the various Internet page categories, and (i) presenting the plurality of Internet banner advertisements to the target audience. The steps (a)-(i) can be repeated as long as the target audience is connecting to the Internet. The steps (h) and (i) are being repeated if the audience responds to the plurality of Internet banner advertisements by clicking any of the plurality of Internet banner advertisements.

The plurality of consecutive Internet pages can be either a single Internet page or a pre-defined number of Internet pages. The pre-defined formula is the plurality of length of time the target audience having spent on each of the plurality of consecutive Internet pages multiplied by the number of the plurality of consecutive Internet pages in each of the plurality of Internet page categories, or the like.

The plurality of Internet banner advertisements in the highest interest Internet page category can be either a single Internet banner advertisement or a pre-defined number of Internet banner advertisement. The highest interest Internet page category can be either a single Internet page category or a plurality of Internet page categories.

The apparatus for effectively reaching a target audience and significantly increasing the efficiency of Internet banner advertisement comprises (a) means for defining various Internet page categories using common categorizing techniques adopted by various Internet search engines, (b) means for categorizing all available Internet banner advertisements into the various Internet page categories, (c) means for sampling a plurality of consecutive Internet pages a target audience having just surfed, (d) means for sampling a plurality of length of time the target audience having spent on each of the plurality of consecutive Internet pages the target audience having just surfed, (e) means for categorizing the plurality of consecutive Internet pages into a plurality of Internet page categories using the common categorizing techniques adopted by various Internet search engines, (f) means for counting number of the plurality of consecutive Internet pages in each of the plurality of Internet page categories, (g) means for ranking the plurality of Internet page categories from a highest interest Internet page category to a lowest interest Internet page based on a pre-defined formula, the plurality of length of time the target audience having spent on each of the plurality of consecutive Internet pages and the number of the plurality of consecutive Internet pages in each of the plurality of Internet page categories being two variables of the pre-defined formula, (h) means for picking a plurality of Internet banner advertisements in the highest interest Internet page category; and the highest interest Internet page category being one of the various Internet page categories, and (i) means for presenting the plurality of Internet banner advertisements to the target audience.

The computer program product recorded on a computer readable medium for a method for effectively reaching a target audience and significantly increasing the efficiency of Internet banner advertisement comprises (a) computer readable means for defining various Internet page categories using common categorizing techniques adopted by various Internet search engines, (b) computer readable means for categorizing all available Internet banner advertisements into the various Internet page categories, (c) computer readable means for sampling a plurality of consecutive Internet pages a target audience having just surfed, (d) computer readable means for sampling a plurality of length of time the target audience having spent on each of the plurality of consecutive Internet pages the target audience having just surfed, (e) computer readable means for categorizing the plurality of consecutive Internet pages into a plurality of Internet page categories using the common categorizing techniques adopted by various Internet search engines, (f) computer readable means for counting number of the plurality of consecutive Internet pages in each of the plurality of Internet page categories, (g) computer readable means for ranking the plurality of Internet page categories from a highest interest Internet page category to a lowest interest Internet page based on a pre-defined formula, the plurality of length of time the target audience having spent on each of the plurality of consecutive Internet pages and the number of the plurality of consecutive Internet pages in each of the plurality of Internet page categories being two variables of the pre-defined formula, (h) computer readable means for picking a plurality of Internet banner advertisements in the highest interest Internet page category, the highest interest Internet page category being one of the various Internet page categories, and (i) computer readable means for presenting the plurality of Internet banner advertisements to the target audience.

### DESCRIPTION OF THE DRAWINGS

Other objects of my invention, as well as particular features, elements, and advantages thereof, will be elucidated in, or apparent from, the following description and the accompanying drawing figures.

Other features of my invention will become more evident from a consideration of the following detailed description of my patent drawings, as follows:

FIGS. 1-3 demonstrates a preferred embodiment for a method, an apparatus and computer program product effectively reaching a target audience and significantly increasing the efficiency of Internet banner advertisement; and

FIGS. 4-6 discloses a second embodiment for a method, an apparatus and computer program product effectively reaching a target audience and significantly increasing the efficiency of Internet banner advertisement.

### DETAILED DESCRIPTION OF THE PREFERRED EMBODIMENT

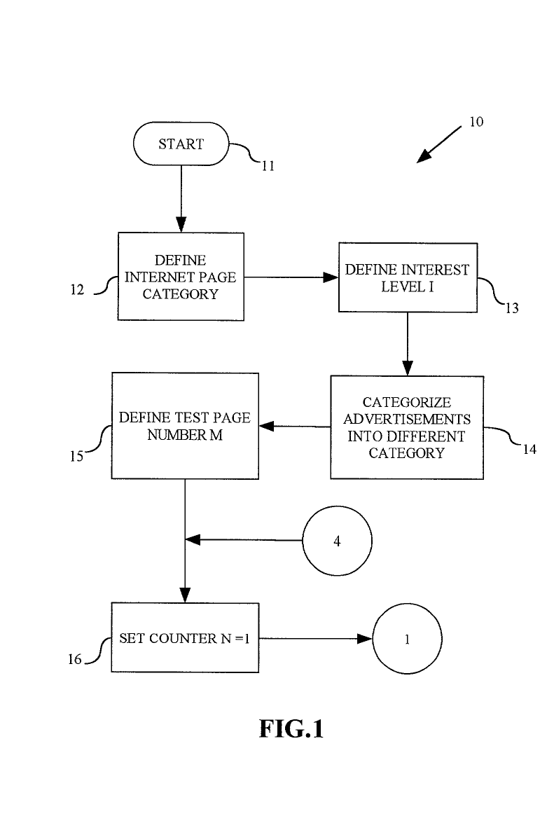

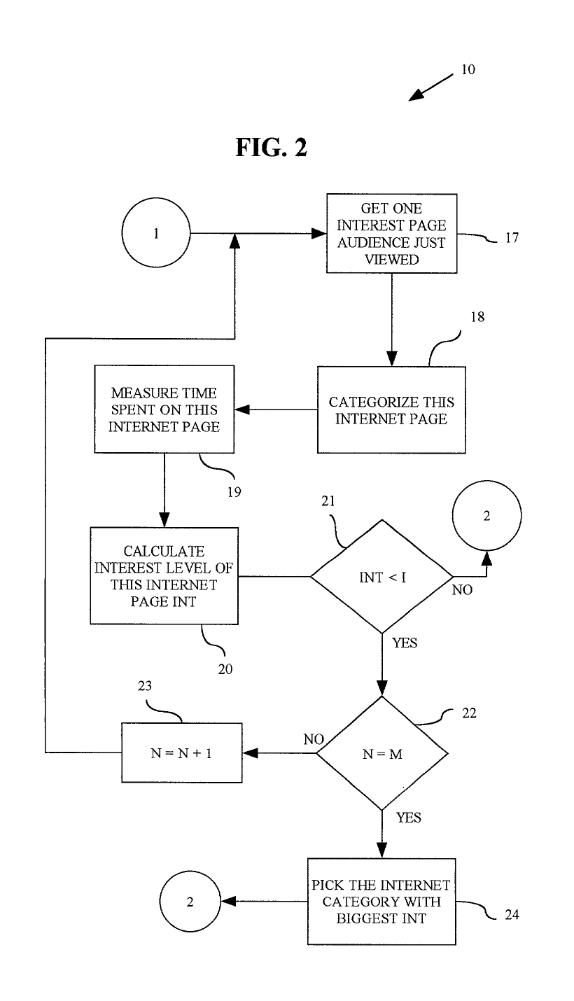

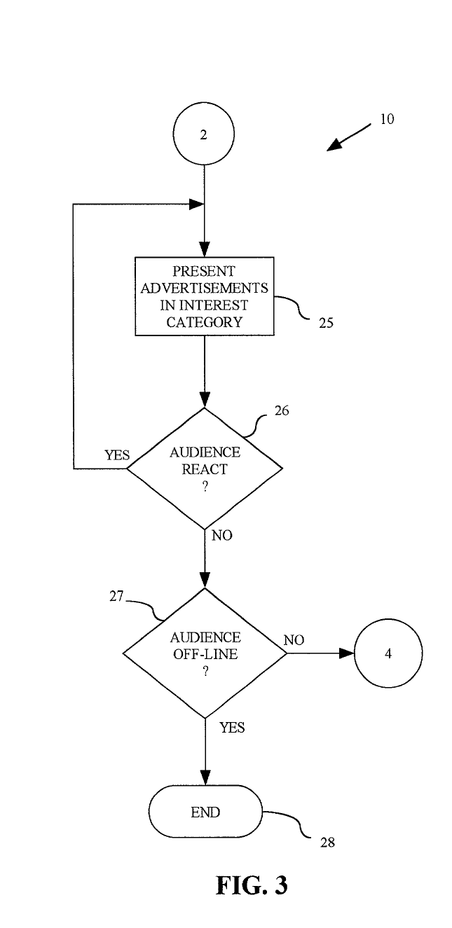

FIGS. 1-3 demonstrates a preferred embodiment for a method, an apparatus and a computer program product effectively reaching a target audience and significantly increasing the efficiency of Internet banner advertisement 10. A procedure starts at block 11, and immediately proceeds to block 12, where the procedure defines various Internet page categories. The existing technologies provide the possibility to categorize unlimited number of Internet pages into finite number of Internet page categories. Various Internet search engines uses these existing technologies to categorize all Internet pages into different categories. The procedure then proceeds to block 13, where the procedure defines an interest level I. The interest level can be defined by the advertiser, or automatically based on the experience with the target audience. The interest level can be defined by the length of time that the target audience has spent on this category of Internet pages and the frequency the target audience has viewed this category of Internet pages, or other factors defined by the advertiser. Until the time that the target audience views an Internet page that meets the interest level, there will only be random advertisements presented to the target audience. The procedure proceeds to block 14, where it categorizes all available advertisements into different categories, which are identical to the Internet page categories. The Procedure proceeds to block 15, where it defines the test page number M. The test page number M is the number of pages viewed by the target audience that the procedure will sample before it can make a decision as to which category or categories of advertisements shall be presented to the target audience. The test page number can be a pre-defined number. The procedure proceeds to block 16, where a counter N is set to 1. The procedure proceeds to block 17, where it gets one Internet page that the target audience just viewed, and proceeds to block 18. At block 18, the procedure categorize the Internet page that the target audience just viewed into an Internet page category, and proceeds to block 19. At block 19, the procedure measures the time that the target audience has spent on the Internet page, and proceeds to block 20. At block 20, the procedure calculates the interest level INT of this Internet page based on a pre-defined formula, of which the time the target audience spent on the Internet page is an important variable. The procedure then proceeds to block 21, where a decision is made to see if INT is less than I. If the answer is YES, the procedure proceeds to block 22, where a decision is made to see if N equals to M. If the answer is NO, the procedure proceeds to block 23, where N increases one, and proceeds to block 17. Returning to block 22. If the answer is YES, the procedure proceeds to block 24, where the procedure decides that one Internet category has the largest INT, and proceeds to block 25. Returning to block 21. If the answer is NO, the procedure proceeds to block 25, where it presents a pre-defined number of advertisements within the interest category to the target audience, and proceeds to block 26. At block 26, a decision is made as to whether the target audience has reacted to the advertisements presented to him by clicking at least one advertisement. If the answer is YES, the procedure goes back to block 25, and presents more advertisements in the same interest category. Returning to block 26. If the answer is NO, the procedure proceeds to block 27. At block 27, a check is made to see if the target audience is off-line. If the answer is NO, the procedure goes back to block 16. Returning to block 27. If the answer is YES, the procedure proceeds to block 28, and ends right there.

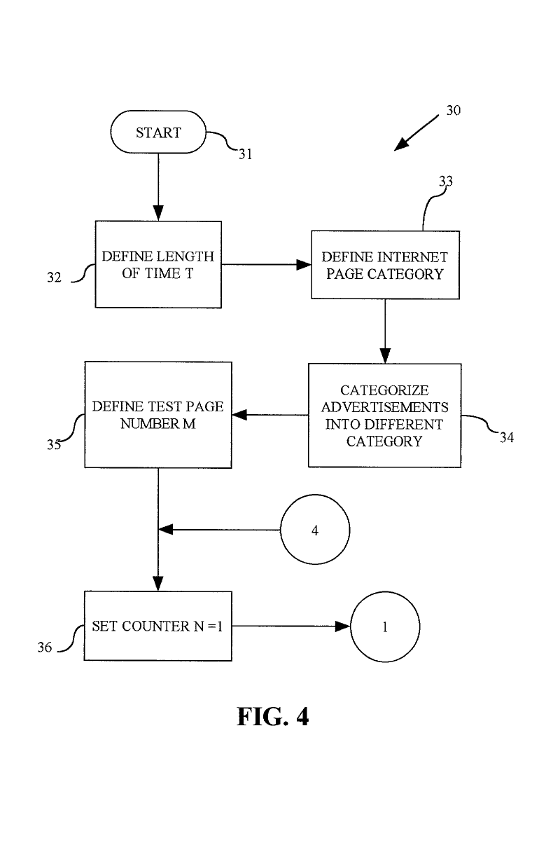

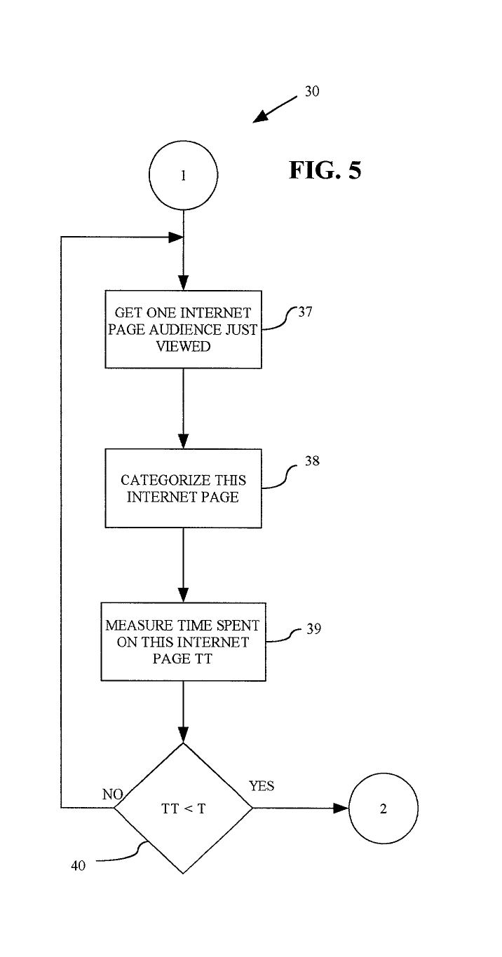

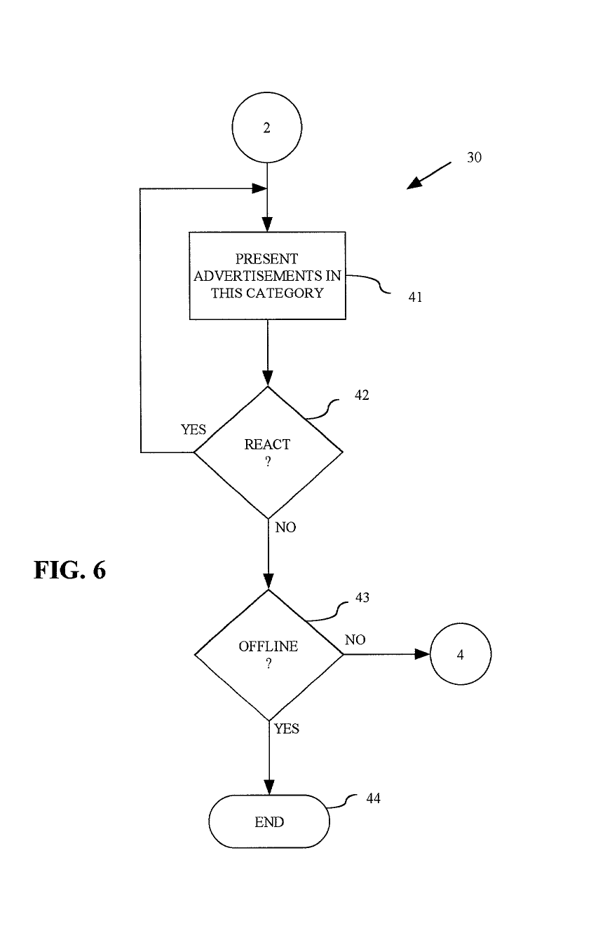

Referring now to FIGS. 4-6, which demonstrates a second embodiment for a method, an apparatus and a computer program product effectively reaching a target audience and significantly increasing the efficiency of Internet banner advertisement 30. A procedure starts at block 31, and proceeds to block 32, where it defines the length of time T. The procedure defines an interest level for a target audience toward a specific Internet page or a specific Internet page category based solely on the length of time the target audience has spent on a specific Internet page. The procedure will only present a group of advertisements in an Internet page category to the target audience if the procedure decides that the target audience's has spent such amount of time, which is longer than T, on the Internet page category. The procedure proceeds to block 33, where it defines various Internet page categories by using the common page categorizing technique used by various Internet search engines. The procedure then proceeds to block 34. At block 34, the procedure categorizes all available advertisements into different categories identical to the Internet page categories, and proceeds to block 35. At block 35, the procedure defines a test page number M, which is the maximum number of Internet pages the target audience shall go through before the procedure starts to present advertisements to the target audience. The procedure proceeds to block 36, where it sets a counter N to 1, and proceeds to block 37. At block 38, the procedure categorizes this Internet page into a related Internet page category, and proceeds to block 39. At block 39, the procedure measures the time TT that the target audience has spent on this Internet page, and documents it, and proceeds to block 40. At block 40, a decision is made to see if TT is smaller than T. If the answer is YES, the procedure proceeds to block 37. Going back to block 40. If the answer is NO, the procedure proceeds to block 41. At block 41, the procedure presents a group of advertisements in the same category as the category of Internet page the target audience just viewed, and proceeds to block 42. At block 42, a decision is made to see if the target audience reacts to the presented advertisements by clicking any of the presented advertisements. If the answer is YES, the procedure proceeds to block 41. Going back to block 42. If the answer is NO, the procedure proceeds to block 43, where a decision is made to see if the target audience is off-line. If the answer is NO, the procedure proceeds to go back to block 37. Returning to block 43, if the answer is YES, the procedure proceeds to block 44, and ends right there.

Hence, the present invention provides a method for effectively reaching a target audience and significantly increasing the efficiency of Internet banner advertisement.

The present invention also provides an apparatus for effectively reaching a target audience and significantly increasing the efficiency Internet banner advertisement.

The present invention further provides a computer program product for effectively reaching a target audience and significantly increasing the efficiency of Internet banner advertisement.

The present invention provides a method for an advertiser to present the Internet banner advertisements to only those target audience, whose interesting level to these advertisements has reached the interesting level pre-defined by the advertiser.

The present invention also provides an apparatus for an advertiser to present the Internet banner advertisements to only those target audience, whose interesting level to these advertisements has reached the interesting level pre-defined by the advertiser.

The present invention further provides a computer program product for an advertiser to present the Internet banner advertisements to only those target audience, whose interesting level to these advertisements has reached the interesting level pre-defined by the advertiser.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

I claim:

1. A method for effectively reaching a target audience and significantly increasing the efficiency of Internet banner advertisement, said method comprising:
(a) defining various Internet page categories using common categorizing techniques adopted by various Internet search engines;
(b) categorizing all available Internet banner advertisements into said various Internet page categories;
(c) sampling a plurality of consecutive Internet pages a target audience having just surfed;
(d) sampling a plurality of length of time said target audience having spent on each of said plurality of consecutive Internet pages said target audience having just surfed;
(e) categorizing said plurality of consecutive Internet pages into a plurality of Internet page categories using said common categorizing techniques adopted by various Internet search engines;
(f) counting number of said plurality of consecutive Internet pages in each of said plurality of Internet page categories;
(g) ranking said plurality of Internet page categories from a highest interest Internet page category to a lowest interest Internet page categories based on a pre-defined formula, said plurality of length of time said target audience having spent on each of said plurality of consecutive Internet pages and said number of said plurality of consecutive Internet pages in each of said plurality of Internet page categories being two variables of said pre-defined formula;
(h) picking a plurality of Internet banner advertisements in said highest interest Internet page category, said highest interest Internet page category being one of said various Internet page categories; and
(i) presenting said plurality of Internet banner advertisements to said target audience.

2. The method of claim 1, wherein the steps (a)-(i) can be repeated.

3. The method of claim 1, wherein said plurality of consecutive Internet pages can be either a single Internet page or a pre-defined number of Internet pages.

4. The method of claim 1, wherein said pre-defined formula is said plurality of length of time said target audience having spent on each of said plurality of consecutive Internet pages multiplied by said number of said plurality of consecutive Internet pages in each of said plurality of Internet page categories, or the like.

5. The method of claim 1, wherein said plurality of Internet banner advertisements in said highest interest Internet page category can be either a single Internet banner advertisement or a pre-defined number of Internet banner advertisement.

6. The method of claim 1, wherein said highest interest Internet page category can be either a single Internet page category or a plurality of Internet page categories.

7. The method of claim 1, wherein the steps (h) and (i) are repeated if said audience responds to said plurality of Internet banner advertisements by clicking any of said plurality of Internet banner advertisements.

8. A method for effectively reaching a target audience and significantly increasing the efficiency of Internet banner advertisement, said method comprising:
(a) sampling a plurality of Internet pages having been surfed by a target audience right before being provided a plurality of Internet banner advertisements;
(b) sampling a plurality of periods of time said target audience having spent on each of said plurality of Internet pages;
(c) picking out a group of Internet pages from said plurality of Internet pages said target audience having spent for more than a pre-defined period of time;
(d) analyzing commonalities among said group of Internet pages;
(e) gathering a plurality of Internet banner advertisements having said commonalities; and
(f) presenting said plurality of Internet banner advertisements having said commonalities to said target audience.

9. The method of claim 8, wherein the steps (a)-(i) can be repeated.

10. The method of claim 8, wherein a plurality of Internet pages can be either a single Internet page or a pre-defined number of Internet pages.

11. The method of claim 8, wherein a plurality of Internet banner advertisements can be either a single Internet banner advertisement or a pre-defined number of Internet banner advertisements.

12. The method of claim 8, wherein said group of Internet pages can be either a single Internet page or a pre-defined number of Internet pages.

13. The method of claim 8, wherein said plurality of Internet banner advertisements can be either a single Internet banner advertisement or a pre-defined number of Internet banner advertisements.

14. The method of claim 8, wherein the steps (e) and (f) are repeated if said audience responds to said plurality of Internet banner advertisements by clicking any of said plurality of Internet banner advertisements.

15. A method for effectively reaching a target audience and significantly increasing the efficiency of Internet banner advertisement, said method comprising:
(a) sampling a plurality of Internet pages, said plurality of Internet pages being either a single Internet page or a pre-defined number of Internet pages, having surfed by a target audience right before being provided a plurality of Internet banner advertisements, said plurality of Internet banner advertisements being either a single Internet banner advertisement or a first pre-defined number of Internet banner advertisements;
(b) sampling a plurality of periods of time said target audience having spent on each of said plurality of Internet pages;
(c) setting up a group of Internet pages, said group of Internet pages being either a single Internet page or a pre-defined number of Internet pages, said target audience having spent more than a pre-defined period of time;
(d) analyzing commonalities among said group of Internet pages;
(e) gathering a plurality of Internet banner advertisements having said commonalities, said plurality of Internet banner advertisements being either a single Internet banner advertisement or a second pre-defined number of Internet banner advertisements; and
(f) presenting said plurality of Internet banner advertisements having said commonalities to said target audience.

16. The method of claim 15, wherein the steps (a)-(i) can be repeated.

17. The method of claim 15, wherein the steps (e) and (f) are repeated if said audience responds to said plurality of Internet banner advertisements by clicking any of said plurality of Internet banner advertisements.

18. An apparatus for effectively reaching a target audience and significantly increasing the efficiency of Internet banner advertisement, said apparatus comprising:
(a) means for defining various Internet page categories using common categorizing techniques adopted by various Internet search engines;
(b) means for categorizing all available Internet banner advertisements into said various Internet page categories;
(c) means for sampling a plurality of consecutive Internet pages a target audience having just surfed;
(d) means for sampling a plurality of length of time said target audience having spent on each of said plurality of consecutive Internet pages said target audience having just surfed;
(e) means for categorizing said plurality of consecutive Internet pages into a plurality of Internet page categories using said common categorizing techniques adopted by various Internet search engines;
(f) means for counting number of said plurality of consecutive Internet pages in each of said plurality of Internet page categories;
(g) means for ranking said plurality of Internet page categories from a highest interest Internet page category to a lowest interest Internet page category based on a pre-defined formula, said plurality of length of time said target audience having spent on each of said plurality of consecutive Internet pages and said number of said plurality of consecutive Internet pages in each of said plurality of Internet page categories being two variables of said pre-defined formula;
(h) means for picking a plurality of Internet banner advertisements in said highest interest Internet page category, said highest interest Internet page category being one of said various Internet page categories; and
(i) means for presenting said plurality of Internet banner advertisements to said target audience.

19. The apparatus of claim 18, wherein said plurality of consecutive Internet pages can be either a single Internet page or a pre-defined number of Internet pages.

20. The apparatus of claim 18, wherein said pre-defined formula is said plurality of length of time said target audience having spent on each of said plurality of consecutive Internet pages multiplied by said number of said plurality of consecutive Internet pages in each of said plurality of Internet page categories, or the like.

21. The apparatus of claim 18, wherein said plurality of Internet banner advertisements in said highest interest Internet page category can be either a single Internet banner advertisement or a pre-defined number of Internet banner advertisement.

22. The apparatus of claim 18, wherein said highest interest Internet page category can be either a single Internet page category or a plurality of Internet page categories.

23. A computer program product recorded on a computer readable medium for a method for effectively reaching a target audience and significantly increasing the efficiency of Internet banner advertisement, said apparatus comprising:
(a) computer readable means for sampling a plurality of Internet pages having been surfed by a target audience right before being provided a plurality of Internet banner advertisements;
(b) computer readable means for sampling a plurality of periods of time said target audience having spent on each of said plurality of Internet pages;
(c) computer readable means for picking out a group of Internet pages from said plurality of Internet pages said target audience having spent for more than a pre-defined period of time;
(d) computer readable means for analyzing commonalities among said group of Internet pages;
(e) computer readable means for gathering a plurality of Internet banner advertisements having said commonalities; and
(f) computer readable means for presenting said plurality of Internet banner advertisements having said commonalities to said target audience.

24. The computer program product of claim 23, wherein a plurality of Internet pages can be either a single Internet page or a pre-defined number of Internet pages.

25. The computer program product of claim 23, wherein a plurality of Internet banner advertisements can be either a single Internet banner advertisement or a pre-defined number of Internet banner advertisements.

26. The computer program product of claim 23, wherein said group of Internet pages can be either a single Internet page or a pre-defined number of Internet pages.

27. The computer program product of claim 23, wherein said plurality of Internet banner advertisements can be either a single Internet banner advertisement or a pre-defined number of Internet banner advertisements.

28. A method for an advertiser to present Internet banner advertisements to a pre-defined target audience, said method comprising:
(a) establishing a pre-defined interest level;
(b) defining various Internet page categories using common categorizing techniques adopted by various Internet search engines;
(c) categorizing all available Internet banner advertisements into said various Internet page categories;
(d) sampling a plurality of Internet pages, said plurality of Internet pages being either a single Internet page or a pre-defined number of Internet pages, having surfed by a target audience right before being provided a plurality of Internet banner advertisements, said plurality of Internet banner advertisements being either a single Internet banner advertisement or a pre-defined number of Internet banner advertisements;
(e) sampling a plurality of periods of time said target audience having spent on each of said plurality of Internet pages;
(f) calculating an interest level based on a pre-defined formula, said pre-defined formula having said plurality of lengths of time said target audience having spent on each of said plurality of consecutive Internet pages and said number of said plurality of consecutive Internet pages in each of said plurality of Internet page categories as two variables; and
(g) presenting a plurality of Internet pages in each of said plurality of Internet page categories with said interest level over said pre-defined interest level.
